(19) United States
(12) Patent Application Publication
(10) Pub. No.: US 2002/0023558 A1
(43) Pub. Date: Feb. 28, 2002

(54) Apparatus for registration of multicolor printing images in a web-fed offset press

(75) Inventor: Kenji Kusunoki, Atsugi-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: KABUSHIKI KAISHA TOKYO KIKAI SEISAKUSHO

(21) Appl. No.: 09/910,057

(22) Filed: Jul. 23, 2001

(30) Foreign Application Priority Data
Aug. 23, 2000 (JP) P2000-252302

(51) Int. Cl. B41F 1/00; B41F 5/04

(52) U.S. Cl. 101/221

(57) ABSTRACT

A web-fed, multicolor, offset perfecting printing press having a stack of printing units each having a combination of a plate cylinder and a blanket cylinder on one side of a continuous web of paper, and another such combination on the other side. Each plate cylinder is split into a pair of halves for printing a pair of images in juxtaposition transversely of the web. For precise registration of the different color images printed by the different printing units on the web, there are provided a pair of axial adjustments coupled to opposite ends of each plate cylinder for causing axial displacement of the respective plate cylinder halves with a view to fine image positioning transversely of the web, and a circumferential adjustment for causing circumferential displacement of either half of each plate cylinder with a view to fine image positioning longitudinally of the web. A separate drive mechanism drives each combination of one plate cylinder and one blanket cylinder, so that each drive mechanism serves the additional purpose of positioning the images longitudinally of the web preparatory to fine positioning.

### BACKGROUND OF THE INVENTION

1. Field of the Invention

This invention relates to printing presses, particularly to offset printing presses, and more particularly to a web-fed, multicolor offset printing press having a plurality of printing units for printing different color images on a continuous web of paper or like printable material, each printing unit having at least one plate cylinder, which is split in part along a plane normal to the cylinder axis into a pair of halves for carrying a pair of printing plates, and at least one blanket cylinder for concurrently printing a pair of images in transverse juxtaposition on the web. Still more particularly, the invention pertains to means in such a split-cylinder printing press for registration of the different color images on the web.

2. Description of the Prior Art

It had long been customary in the art to drive the printing units, folding mechanism, tension and conveyor rollers, cooling system, etc., all by one electric motor. The printing presses built on this general scheme were objectionable by reason of the complex gear trains and other linkages required, which demand manufacture and assemblage of numerous parts and components.

Japanese Unexamined Patent Publication No. 8-85196 teaches how to overcome this problem of the more conventional machines, suggesting use of a finely controllable electric motor for driving each combination of a plate cylinder and a blanket cylinder, and each of various other mechanisms and functionally associated groups of parts of the press. It also teaches to increment or decrement the rotational speed of the motor driving each plate- and blanket-cylinder combination for repositioning of the printings on the web in its longitudinal direction.

According to this unexamined patent publication, however, the motor driving each plate- and blanket-cylinder combination is arranged in axial alignment with the plate cylinder. This motor arrangement is not applicable to split plate cylinders of a multicolor press because then the pair of halves of each plate cylinder cannot possibly be made independently displaceable for image registration on the web. That publication is also silent on how to make the plate cylinders adjustable axially for transverse image registration on the web.

Japanese Patent No. 2,866,071 also deals with multicolor presses with unsplit plate cylinders that are capable of image registration longitudinally of the web, but differs from the first cited reference in teaching how to make the plate cylinders axially displaceable for image registration transversely of the web. Each plate cylinder is coupled coaxially to its drive motor, which is accelerated or decelerated for longitudinal image registration. For transverse registration, on the other hand, the cylinder drive motor is specially devised to allow axial displacement of its output shaft with the associated plate cylinder.

Although capable of axial readjustment of each complete plate cylinder, the noted patent does not lend itself to the independent positional control of the pair of halves of split plate cylinders, either. It is additionally objectionable in more respects than one in conjunction with its mechanism for axial displacement of the plate cylinder.

First of all, each cylinder drive motor is so made that the rotor together with the motor output shaft is axially displaceable relative to the motor stator. Such rotor displacement tends to give rise to variations in magnetic flux density within the motor, resulting in changes in motor output torque. This drawback was sought to be remedied by increasing the axial dimension of the rotor with a view to minimization of the effects of output torque fluctuations. The remedy is unsatisfactory first because of the greater space requirement of the motor, and secondly because, no matter how reduced they may be, the flux density variations cause perturbations of the motor output shaft and hence of the plate cylinder.

A further objection to the cited Japanese patent concerns the arrangement of the mechanism for axial adjustment of the plate cylinder parallel to its axis. This arrangement is questionable in terms of efficiency of power transfer to the plate cylinder. It may be practicable if, as indicated in the specification of that patent, the plate cylinder is hollow, but certainly not with solid, and therefore much heavier, as solid plate cylinders of offset printing, such as those for newspaper production.

As a still further objection, difficulties were experienced in mounting to the motor output shaft an encoder for detection of the angular position of the plate cylinder, because of the joint axial displacement of the motor output shaft with the plate cylinder shaft. Very special devices were needed for its mounting. These devices were, moreover, highly susceptible to manufacturing and mounting errors, which manifest themselves as inaccuracies in the encoder output and hence in the positioning of the images longitudinally of the web.

Japanese Patent No. 2,566,895 differs from the two foregoing references in teaching independent positional readjustment of the pair of halves of each split plate cylinder in both axial and circumferential directions of the cylinder. This patent discloses an offset perfecting press, such that each printing unit has two plate- and blanket-cylinder combinations, one on each side of the web, with the blanket cylinder on either side of the web utilizing the blanket cylinder of the other side as impression cylinder. But one electric motor is used for driving the total of four halves of the two split plate cylinders, and two blanket cylinders, of each printing unit. Also included are a pair of axial adjustments for fine repositioning of the pair of plate cylinder halves with a view to image registration transversely of the web, and a pair of circumferential adjustments for fine repositioning of the plate cylinder halves with a view to image registration longitudinally of the web. Still further, the patent is absent from the shortcomings set forth above in connection with the second cited reference with regard to axial repositioning of the plate cylinder.

Offsetting these advantages are the complex linkages required for driving the four plate cylinder halves and two blanket cylinders from the single motor. The relative angular positions of all these rotary parts had to be maintained solely by the mechanical linkages, so that they were not disconnectable from one another even when the press was out of printing operation. Thus, for instance, when one plate cylinder was revolved for mounting printing plates to its halves, the other plate cylinder of the same printing unit turned simultaneously, presenting a hazard to the printing plant personnel.

An additional drawback of the last cited Japanese patent is the complexity of the circumferential adjustments of the plate cylinder halves in particular. Besides being expensive of manufacture, they demanded inordinately high running costs.

### SUMMARY OF THE INVENTION

The present invention aims at the provision of an offset printing press having axial and circumferential adjustments of improved construction capable of independently repositioning the pair of halves of each plate cylinder in cooperation with drive linkages for each plate- and blanket-cylinder combination, for fine image repositioning both transversely and longitudinally of the web.

Another object of the invention is to enable the drive means for each plate- and blanket-cylinder combination to reposition the images longitudinally of the web, in addition to fine repositionings by the axial and circumferential adjustments.

Still another object of the invention is to improve the efficiency of power transmission from the adjustments to the respective halves of each plate cylinder.

A further object of the invention is, in its application to an offset perfecting press, to provide separate drive means and separate adjustment means for each of the pair of plate- and blanket-cylinder combinations of each printing unit, in order that printing plates may be mounted to, and dismounted from, the split plate cylinder of either one plate- and blanket-cylinder combination totally independently of the other such combination of the same printing unit.

Stated broadly, the present invention concerns, in a web-fed offset printing press for printing on a continuous web of paper or like material traveling along a predefined path at a predetermined speed, the combination comprising a plate cylinder and a blanket cylinder in rolling contact with each other. The plate cylinder is split into a pair of halves for printing a pair of images in juxtaposition transversely of the web, the pair of halves of the plate cylinder being capable of independent displacement both axially and circumferentially of the plate cylinder. For image registration there are provided axial adjustment means for causing axial displacement of each half of the plate cylinder independently of the other half with a view to fine positioning of each of the pair of images transversely of the web, and circumferential adjustment means for causing circumferential displacement of a preselected one of the halves of the plate cylinder relative to the other half with a view to fine positioning of one of the pair of images longitudinally of the web. Also taking part in image registration are drive means for jointly driving the plate cylinder and the blanket cylinder in opposite directions at a predetermined speed during printing. The drive means serve the additional purpose of adjustably varying the rotational speed of the plate cylinder with respect to the traveling speed of the web with a view to jointlly positioning of the pair of images longitudinally of the web.

More specifically, the printing press according to the invention is of the type having a series of printing units of identical make for printing different color images on the web. Each printing unit has the split plate cylinder and the blanket cylinder, as set forth above. The plate cylinder has a first pair of helical gears on its opposite ends, and the blanket cylinder a second pair of helical gears on its opposite ends. The first and the second pairs of helical gears are interengaged and coupled to the cylinder drive means for joint rotation of the plate cylinder and the blanket cylinder in opposite directions, as well as for the noted image positioning longitudinally of the web. The circumferential adjustment means are coupled to one of the first pair of helical gears for causing circumferential displacement of the preselected plate cylinder half, and hence for fine positioning of one of the pair of images longitudinally of the web, by causing axial displacement of that helical gear in sliding engagement with one of the second pair of helical gears.

So constructed, the printing press permits approximate positional control of the pair of images longitudinally of the web by the cylinder drive means, as the angular positions of both halves of the plate cylinder are readjusted in either direction. Then the cylinder drive means may again be utilized to finely bring one of the plate cylinder halves, the one not coupled to the circumferential adjustment means, to the correct angular position relative to the web. Then the other plate cylinder half may be fine positioned circumferentially by the circumferential adjustment means. Then both plate cylinder halves may be axially fine positioned by the respective axial adjustment means.

With the cylinder drive means utilized for approximate and fine positional control of both plate cylinder halves as above, the printing press is much more simplified in construction than in the presence of a dedicated positioning mechanism in addition to the cylinder drive mechanism. Even if the pair of images being printed are greatly out of register, longitudinally of the web, with respect to the other pairs of images being printed by the other printing units, the pair of plate cylinder halves may be jointly displaced circumferentially by accelerating or decelerating the plate cylinder relative to the traveling speed of the web. The pair of plate cylinder halves can then be individually fine positioned, both transversely and longitudinally of the web, by the axial and the circumferential adjustment means in cooperation with the cylinder drive means.

Such image positioning by the cylinder drive means affords a substantial curtailment of the total time required for image registration and, in consequence, a substantial saving of paper wasted during that time.

As a further advantage, unlike Japanese Patent No. 2,866,071, supra, most parts of the axial adjustment means are arranged in axial alignment with the plate cylinder. Most efficient power transmission is therefore possible from the adjustment means to the respective halves of the plate cylinder, realizing smooth axial displacement of the plate cylinder halves no matter how heavy they may be.

A still further advantage of this invention manifests itself when each printing unit of the press is of the familiar offset perfecting press configuration, having one plate- and blanket-cylinder combination on one side of the web, and another such combination on the other side. Two separate cylinder drive mechanisms, as well as two separate axial, and two separate circumferential, drive means, are provided for the respective plate- and blanket-cylinder combinations for separately driving them and separately positionally controlling the plate cylinders.

The provision of the two cylinder drive mechanisms makes it possible to mount and dismount printing plates to and from each plate cylinder by turning this plate cylinder independently of the other. The task of plate mounting and dismounting will therefore be performed more efficiently and with less hazard to the printing plant personnel.

The above and other objects, features, and advantages of this invention will become more apparent, and the invention itself will be best understood, from a study of the following description taken together with the attached drawings showing some preferable embodiments of the invention.

### BRIEF DESCRIPTION OF THE DRAWINGS

FIG. 1 is a diagrammatic illustration of a web-fed, multicolor, offset perfecting press to which the instant invention finds application, the press having a stack of four or more printing units for printing as many different color images;

FIG. 2 is an enlarged top plan, partly shown in section for clarity, of one of the printing units of the FIG. 1 printing press, the printing unit having two plate- and blanket-cylinder combinations for printing on both sides of the web;

FIG. 3 is a still more enlarged, fragmentary horizontal section, partly shown in plan for illustrative convenience, of one of the two plate- and blanket-cylinder combinations of FIG. 2, showing in particular one of the pair of axial adjustments, and one circumferential adjustment, for each split plate cylinder;

FIG. 4 is a view similar to FIG. 3 but showing in particular the other of the pair of axial adjustments;

FIG. 5 is also a view similar to FIG. 3 but showing in particular one of the pair of axial adjustments, and one circumferential adjustment, for each split plate cylinder in an alternative embodiment of the invention; and

FIG. 6 is a view similar to FIG. 4 but showing in particular the other of the pair of axial adjustments in the alternative embodiment of the invention.

### DESCRIPTION OF THE PREFERRED EMBODIMENTS

### General

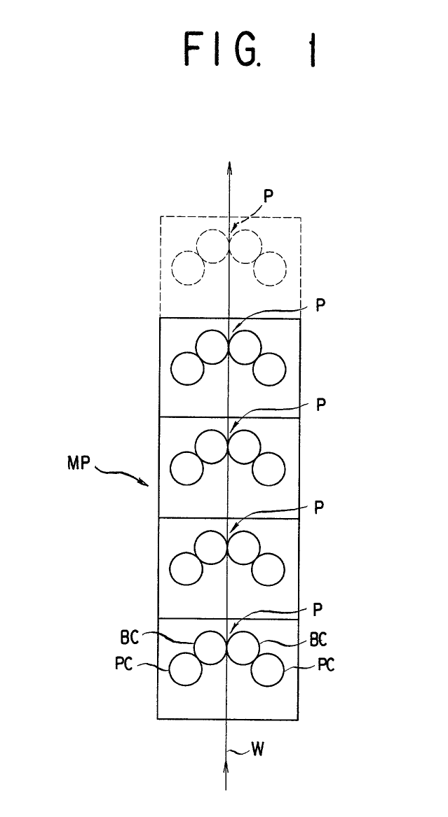

A typical application of the present invention is a multicolor, offset perfecting press such as that pictured diagrammatically in FIG. 1. The representative press MP has four or more printing units P of identical design stacked one upon another. Each printing unit P comprises a combination of one split plate cylinder PC and one blanket cylinder BC which are in rolling contact with each other, and another similar combination of plate and blanket cylinders. The two plate- and blanket-cylinder combinations are of symmetrical arrangement with respect to a predefined path of a continuous web W of paper, which extends vertically through the stack of printing units P. The plate cylinders PC print images on the respective blanket cylinders BC, from which the images are offset or transferred to both sides of the web W at one time, using the familiar blanket-to-blanket method of image transfer to the web.

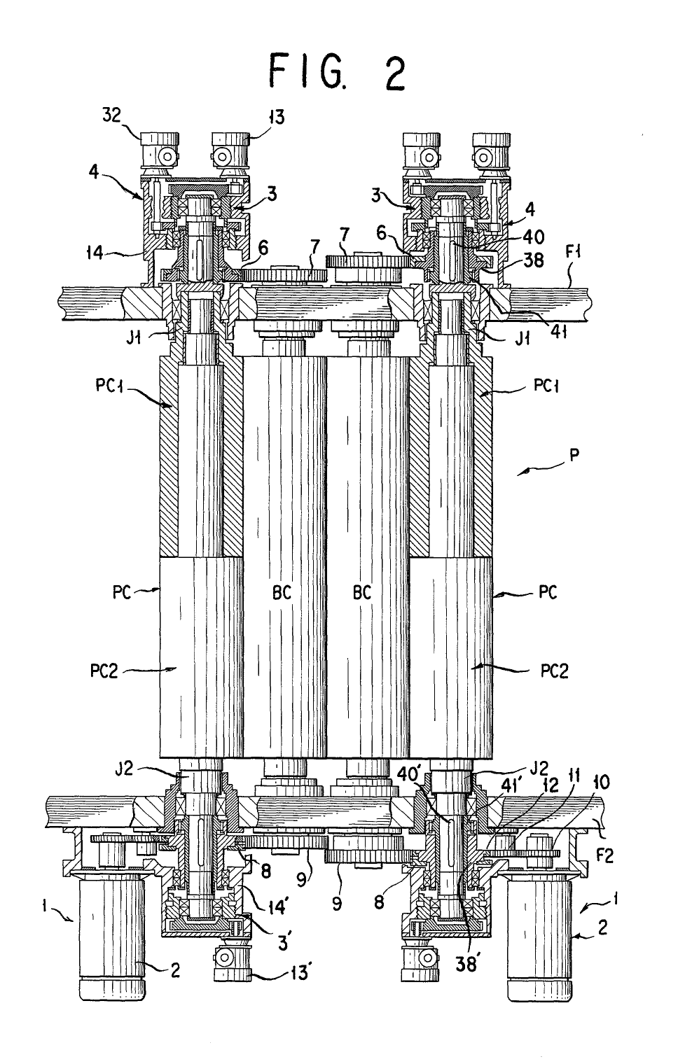

Reference may be had to FIG. 2 for more detailed study of each printing unit P. It will be noted that each plate cylinder PC is bisected in part along a plane at right angles with the cylinder axis into a pair of halves PC₁ and PC₂ for carrying separate printing plates, not shown. The plate cylinder halves PC₁ and PC₂, and therefore the unshown printing plates to be carried thereby, are independently movable both axially and circumferentially relative to each other for fine image registration both transversely and longitudinally of the web, besides being jointly rotatable for printing and for approximate and fine image registrations longitudinally of the web.

For the last mentioned two purposes, the two plate- and blanket-cylinder combinations are driven by respective cylinder drive mechanisms 1 each including a variable speed electric motor (hereinafter referred to as cylinder drive motor) 2. Driven by one such cylinder drive motor 2, each couple of plate cylinder PC and blanket cylinder BC revolve in opposite directions, both during printing and for approximate and fine image registration longitudinally of the web W.

The two halves PC₁ and PC₂ of each plate cylinder are provided respectively with axial adjustments 3 and 3′ thereby to be individually displaced axially of the plate cylinder for fine image positioning transversely of the web. The first half PC₁ of each plate cylinder is additionally provided with a circumferential adjustment 4 thereby to be independently displaced circumferentially of the plate cylinder for fine image positioning longitudinally of the web.

Each plate cylinder PC of each printing unit P has a pair of pivots or trunnions J₁ and J₂ extending coaxially from its opposite ends and rigidly coupled one to each plate cylinder halves PC₁ or PC₂. Each pair of trunnions J₁ and J₂ are rotatably mounted to a pair of framing walls F₁ and F₂. It is understood that each blanket cylinder BC is likewise supported by and between the pair of framing walls F₁ and F₂.

Hereinafter in this specification the above noted cylinder drive mechanisms 1, axial adjustments 3 and 3′, and circumferential adjustments 4 of each printing unit P will be described in more detail, in that order and under separate headings. Operational description will follow the discussion of the listed components.

### Cylinder Drive Mechanisms

As will be noted from FIG. 2, the pair of plate- and blanket-cylinder combinations of each printing unit P are driven by the respective drive mechanisms 1 of identical design each including the cylinder drive motor 2. Only one cylinder drive mechanism will therefore be described in detail in conjunction with one associated plate- and blanket-cylinder combination, it being understood that the same description applies to the other.

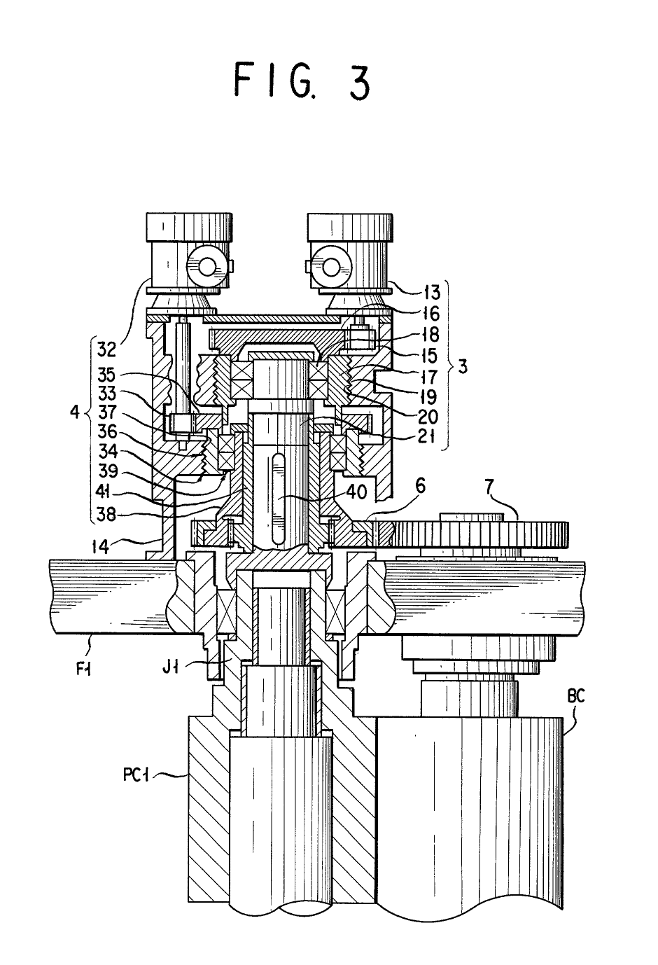

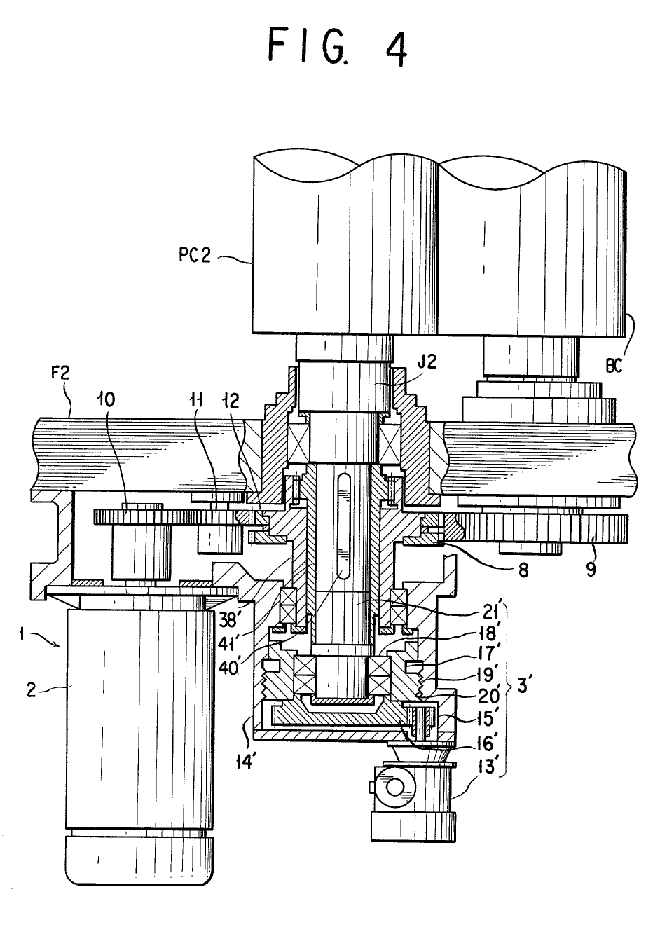

The representative cylinder drive mechanism 1, which is for the left-hand plate- and blanket-cylinder combination as seen in FIG. 2, is shown on an enlarged scale in FIGS. 3 and 4. With reference to FIG. 3 a helical gear 6 is mounted on the trunnions J₁ for joint rotation with the first plate cylinder half PC₁. In mesh with the helical gear 6 is another such gear 7 coupled fast to one end of the blanket cylinder BC.

FIG. 4 shows a third helical gear 8 mounted on the trunnions J₂ for joint rotation with the second plate cylinder half PC₂. This third gear 8 is in mesh with a fourth helical gear 9 rigidly coupled to the blanket cylinder BC for joint rotation therewith.

The third helical gear 8 additionally meshes with a drive pinion 10 on the output shaft of the cylinder drive motor 2 via one or more, two in this particular embodiment, intermediate gears 11 and 12. The intermediate gear 12 is shown mounted coaxially on the plate cylinder trunnions J₂ for rotation relative to the same and hence to the second plate cylinder half PC₂. The rotation of the drive pinion 10 is therefore first imparted via the intermediate gears 11 and 12 to the driven gear 9 on one end of the blanket cylinder BC and thence back to the other driven gear 8 on the plate cylinder trunnions J₂. This intermediate gear arrangement is recommended for its less space requirement.

Thus the two halves PC₁ and PC₂ of the plate cylinder PC will be driven jointly from the cylinder drive motor 2 via the blanket cylinder BC. The direction of rotation of the plate cylinder halves PC₁ and PC₂ will be opposite to that of the blanket cylinder BC. It is understood that the other plate cylinder PC of each printing unit P, FIG. 1, is likewise driven from its own drive mechanism.

### Axial Adjustments

The pair of axial adjustments 3 and 3′ for the respective plate cylinder halves PC₁ and PC₂ are illustrated in detail in FIGS. 3 and 4, respectively. Since they are essentially alike in construction, only the axial adjustment 3 for the first plate cylinder half PC₁ will be explained with reference to FIG. 3, and the various parts of the other adjustment 3′ will be identified in FIG. 4 by priming the reference numerals used to denote the corresponding parts of the adjustment 3.

The representative axial adjustment 3 includes a bidirectional electric motor (hereinafter referred to as axial adjustment motor) 13, which is mounted fast to a mounting subframe unit 14 of approximately tubular shape fastened to the framing wall F₁. A drive pinion 15, which is a spur gear, on the output shaft of the axial adjustment motor 13 meshes with a driven gear 16. Coaxially coupled to the driven gear 16 for joint rotation therewith is a sleeve 17 which carries a set of bearings 18 and which is toothed externally at 19 for engagement with a set of internal teeth 20 formed on the subframe unit 14. Consequently, the sleeve 17 undergoes axial displacement relative to the subframe unit 14 upon rotation with the driven gear 16.

Journaled in the bearing set 18 is an extension 21 of the plate cylinder trunnion J₁, which extension is collared to engage the bearing set 18 at both ends thereof, locking the same against axial displacement in either direction relative to the plate cylinder trunnion. Additionally, the bearing set 18 has its opposite ends engaged by the driven gear 16 and sleeve 17, which are themselves locked against axial displacement relative to each other and constrained to joint rotation. Thus, upon rotation with the driven gear 16, the sleeve 17 will undergo axial displacement relative to the subframe unit 14. The bearing set 18 will convey only the axial displacement of the sleeve 17 to the plate cylinder trunnion extension 21, thence to the plate cylinder trunnion J₁, and thence to the first plate cylinder half PC₁. This plate cylinder half will then travel toward and away from the second plate cylinder half PC₂ for image positioning transversely of the web.

### Circumferential Adjustments

Reference is directed to FIG. 3 for discussion of the circumferential adjustment 4 for the first half PC₁ of the left hand (as seen in FIG. 1) plate cylinder PC of each printing unit P.

The circumferential adjustment 4 includes another bidirectional electric motor (hereinafter referred to as circumferential adjustment motor) 32 mounted to the subframe unit 14. A drive pinion 33, also a spur gear, on the output shaft of the circumferential adjustment motor 32 meshes with a driven gear 35, which is coaxially secured to a sleeve 34 concentrically carrying a set of bearings 39. The sleeve 34 is externally screw-threaded at 36 for engagement with a set of internal threads 37 formed on the subframe unit 14. Thus the sleeve 34 undergoes axial displacement relative to the subframe unit 14 upon rotation with the driven gear 35.

Journaled in the bearing set 39 is a tubular extension of an annular gear 38, which is locked against axial displacement in either direction relative to the bearing set and to the sleeve 34. The annular gear 38 is toothed internally to mesh with the external teeth of another annular gear 41. The sets of teeth on these annular gears 38 and 41 are both parallel to their axis, so that the gears are capable of axial displacement relative to each other although they are constrained to joint rotation. The annular gear 41 is keyed at 40 to the plate cylinder trunnion J₁, which is thus forced to rotate with the gear 41 but which is free to travel axially relative to the same. The aforesaid helical gear 6, in mesh with the other helical gear 7 rotatable with the blanket cylinder BC, is mounted fast to the internal gear 38.

Therefore, upon axial displacement of the sleeve 34 with the driven gear 35, and hence of the internal gear 38 with the helical gear 6 relative to the annular gear 41, the helical gear 6 will be angularly displaced by virtue of its engagement with the other helical gear 7 on the blanket cylinder BC, the latter gear being incapable of axial motion. Only this angular displacement of the helical gear 6 will be transmitted via the annular gears 38 and 41 to the plate cylinder trunnion J₁, resulting in the circumferential adjustment of the first plate cylinder half PC₁.

### Operation

A pair of printing plates are mountable to the respective halves PC₁ and PC₂ of each plate cylinder PC of each printing unit P totally independently of the other plate cylinder thereof thanks to the provision of the separate cylinder drive mechanisms 1 for the respective plate- and blanket-cylinder combinations of each printing unit. The plate cylinder PC may be driven slowly by the associated cylinder drive motor 2 during such printing plate mounting. The associated blanket cylinder BC will turn in a direction opposite to that of the plate cylinder, as during printing to be explained in the following.

After the mounting of printing plates to all the plate cylinders PC of all the printing units P, printing may be started by setting the pairs of cylinder drive motors 2 of all the printing units into rotation at a prescribed printing speed under the direction of control electronics which falls outside the scope of this invention. The operational description will be limited hereinbelow to one plate- and blanket-cylinder combination for simplicity, as such description applies to any other such combination of this multicolor printing press MP.

With reference to FIG. 4 the rotation of one cylinder drive motor 2 will be transmitted from the helical drive pinion 10 to the helical driven gear 9 on one end of the blanket cylinder BC via the intermediate gears 11 and 12. The blanket cylinder BC will then rotate with the other helical driven gear 7, FIG. 3, on the other end thereof, with the consequent power transmission from the pair of helical gears 7 and 9 on the opposite ends of the blanket cylinder BC to the pair of helical gears 6 and 8 on the opposite ends of the plate cylinder PC.

The rotation of the helical gear 6 on one end of the plate cylinder PC will be transmitted to the first plate cylinder half PC₁ by way of the intermeshing annular gears 38 and 41, key 40, and plate cylinder trunnion J₁. The rotation imparted to the helical gear 8, FIG. 4, on the other end of the plate cylinder PC will be transmitted to the second plate cylinder half PC₂ by way of the intermeshing annular gears 38′ and 41′, key 40′, and plate cylinder trunnion J₂.

Thus the two halves PC₁ and PC₂ of the plate cylinder PC will jointly rotate in a direction opposite to that of the blanket cylinder BC. As the plate- and blanket-cylinder combinations of all the printing units P are driven in a like manner, multicolor images will be printed on both sides of the web W traveling between the blanket cylinders BC of each printing unit.

Possibly, the two pairs of images printed on both sides of the web in any one of the printing units P may be relatively greatly out of register with each other. It is also likely that the pair of images printed on either side of the web by one plate- and blanket-cylinder combination of any printing unit be relatively greatly out of register with the other pairs of images printed in superposition on the same side of the web by the other printing units P. It is in these cases that the desired pair or pairs of images should be approximately and then finely repositioned longitudinally of the web by the cylinder drive mechanism or mechanisms 2 of any required printing unit preparatory to fine repositioning by the axial adjustments 3 and 3′ and circumferential adjustment 4.

For such image repositioning, the cylinder drive motor or motors 2 may be advanced or delayed in speed with respect to the traveling speed of the web W, that is, to the rotational speed of the other cylinder drive motor of the same printing unit or to that of the cylinder drive motors of the other printing units. The pair of halves PC₁ and PC₂ of each desired plate cylinder will then be jointly displaced circumferentially relative to the other plate cylinder halves, until the desired pair of images come into approximate register with the other pairs of images.

If the second half PC₂ of one plate cylinder proves to be still somewhat out of phase with the second halves of the other plate cylinders, the cylinder drive motor 2 may again be accelerated or decelerated to an extent necessary to bring the associated image into fine and exact register with the other images. This secondary readjustment, being also done by the cylinder drive motor 2, will be accompanied the simultaneous angular displacement of the first plate cylinder half PC₁ with the second PC₂. It is therefore desirable that the first cylinder half PC₁ be concurrently circumferentially readjusted by the circumferential adjustment 4, although such concurrent readjustment is not a necessity.

If the first plate cylinder half PC₁ is found slightly out of phase longitudinally of the web, the circumferential adjustment motor 32 of the circumferential adjustment 4 may be rotated a required angle in a required direction. As has been explained, the motor rotation will result in the circumferential displacement of the first plate cylinder half PC₁ due in part to the intermeshing helical gears 6 and 7. The first plate cylinder half PC₁ will then print images on the web in precise register, longitudinally of the web, with the other images printed by the other first plate cylinder halves on the same side of the web.

The two halves PC₁ and PC₂ of each plate cylinder may also be individually displaced transversely of the web relative to the corresponding halves of the other plate cylinders. Then the axial adjustment motors 13 and 13′ of the axial adjustments 3 and 3′ may be rotated each through a required angle in a required direction. The plate cylinder halves PC₁ and PC₂ will then print images on the web in precise register, transversely of the web, with the other images printed by the respective halves of the other plate cylinders.

### Alternate Embodiment

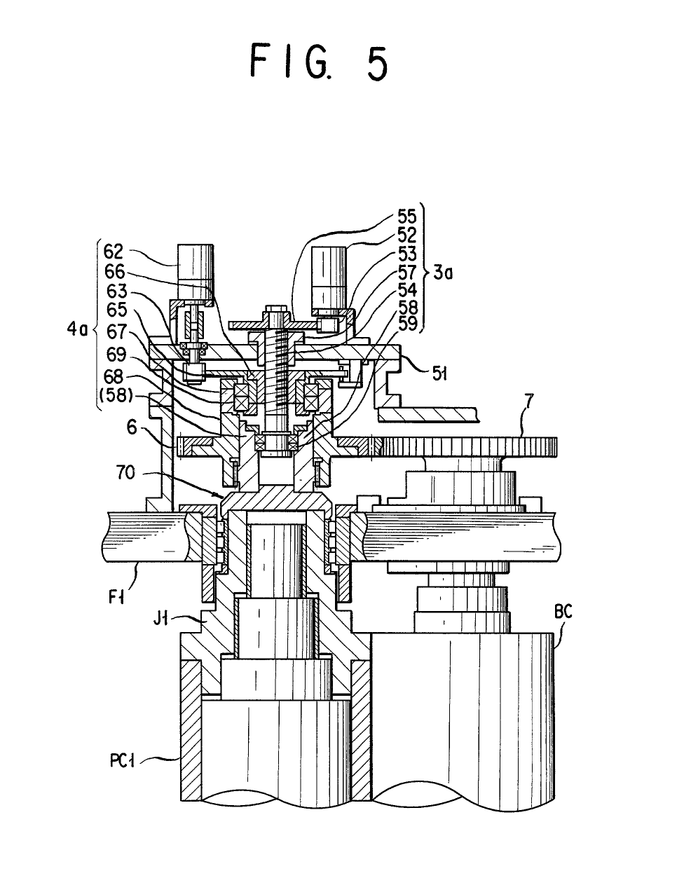

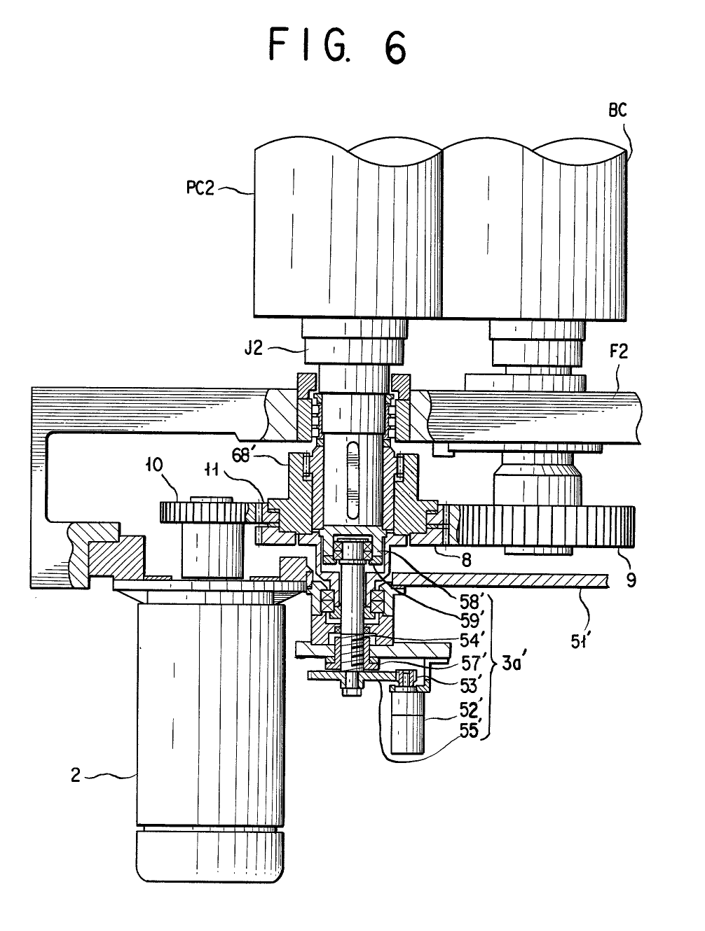

The axial adjustment 3 and circumferential adjustment 4 of FIG. 3 are replaceable by axial adjustment 3a and circumferential adjustment 4a of FIG. 5, and the axial adjustment 3′ of FIG. 4 by axial adjustment 3a′ of FIG. 6. The alternative pair of axial adjustments 3a and 3a′ are also of like construction, so that only the axial adjustment 3a for the first plate cylinder half PC₁ will be described with reference to FIG. 5, and the various parts of the other axial adjustment 3a′ will be identified in FIG. 6 by priming the reference numerals used to denote the corresponding parts of the representative adjustment 3a.

The representative axial adjustment 3a has a bidirectional axial adjustment motor 52 mounted to a subframe unit 51 on the framing wall F₁. A drive pinion 53 of spur gear design on the output shaft of the axial adjustment motor 52 meshes with a driven gear 55 mounted fast to one end of a threaded rod 54. The threaded rod 54 extends through, and is threadedly engaged with, an internally threaded sleeve 57 secured to the subframe unit 51, so that the threaded rod will travel longitudinally back and forth relative to the subframe unit with the bidirectional rotation of the axial adjustment motor 52.

The other end of the threaded rod 54 is rotatably received in another sleeve 58 via a set of bearings 59. This second sleeve 58 is coaxially secured to the trunnion J₁ and thence to the first plate cylinder half PC₁. The bearing set 59 has its opposite ends engaged by the threaded rod 54 and the second sleeve 58 to be locked against axial displacement in either direction relative to these parts. Consequently, the axial displacement of the threaded rod 54 is transmitted via the bearing set 59, second sleeve 58 and trunnion J₁ to the first plate cylinder half PC₁, which will then travel axially for image repositioning transversely of the web.

With reference directed also to FIG. 5 the modified circumferential adjustment 4a has a bidirectional circumferential adjustment motor 62 which also is mounted to the subframe unit 51. A drive pinion 63 on the output shaft of the circumferential adjustment motor 62 meshes with a driven gear 65 of concentric arrangement with the threaded rod 54 set forth in conjunction with the axial adjustment 3a. The driven gear 65 rigidly and concentrically carries an internally threaded sleeve 66 fitted over, and engaged with, the threaded rod 54. When driven, therefore, the gear 65 not only rotates but travels axially on the threaded rod 54. It is thus seen that this threaded rod forms a functioning part of both axial adjustment 3a and circumferential adjustment 4a.

The internally threaded sleeve 66 is rotatably and concentrically coupled via a set of bearings 69 to a second sleeve 67, which substantially is of one-piece construction with an internally toothed annular gear 68. The bearing set 69 has its opposite ends engaged by the driven gear 65 and the second sleeve 67 against axial displacement in either direction relative to these parts, so that only the axial travel of the driven gear 65 is transmitted to the second sleeve and thence to the internal gear 68.

The internal gear 68 concentrically surrounds the sleeve 58 which has been set forth in relation to the axial adjustment 3a. Coaxially secured to the plate cylinder trunnion J₁ via the end cap 70, the sleeve 58 is threaded externally to mesh with the internal gear 68, in such a manner that, although constrained to joint rotation, these intermeshing parts 58 and 68 are still capable of axial displacement relative to each other. Thus the sleeve 58 constitutes another active part shared by the axial adjustment 3a and circumferential adjustment 4a. The noted helical gear 6, in mesh with the driving helical gear 7 on the blanket cylinder BC, is mounted fast on the internal gear 68, so that the rotation of the helical gear 6 is transmitted to the plate cylinder trunnion J₁ via the internal gear 68, sleeve 58, and end cap 70.

Thus, for circumferential positioning of the plate cylinder half PC₁, the bidirectional axial displacement of the driven gear 65 will be transmitted to the sleeve 67 and hence to the internal gear 68. Traveling axially with the internal gear 68, the helical gear 6 will be angularly displaced because of its slidable engagement with the other helical gear 7. This angular motion of the helical gear 6 will be conveyed via the intermeshing parts 58 and 68 to the trunnion J₁ and thence to the plate cylinder half PC₁.

Preferably, in this alternate embodiment, the threaded rods 54 and 54′ and the internal gears 57, 57′ and 66 should be interengaged via series of antifriction balls, not shown, rollably confined between their threads. These parts will then move relative to each other with a minimum of friction and play.

Notwithstanding the foregoing detailed disclosure it is not desired that the present invention be limited by the exact details of the illustrated embodiments or by the description thereof; instead, the invention should be construed broadly and in a manner consistent with the fair meaning or proper scope of the subjoined claims.

What is claimed is:

1. In a web-fed offset printing press for printing on a continuous web of paper or like material traveling along a predefined path at a predetermined speed, in combination:
(a) a plate cylinder split into a pair of halves for printing a pair of images in juxtaposition transversely of the web, the pair of halves of the plate cylinder being capable of independent displacement both axially and circumferentially of the plate cylinder;
(b) a blanket cylinder in rolling contact with the plate cylinder;
(c) axial adjustment means for causing axial displacement of each half of the plate cylinder independently of the other half with a view to fine positioning of each of the pair of images transversely of the web;
(d) circumferential adjustment means for causing circumferential displacement of a preselected one of the halves of the plate cylinder relative to the other half with a view to fine positioning of one of the pair of images longitudinally of the web; and
(e) drive means for jointly driving the plate cylinder and the blanket cylinder in opposite directions at a predetermined speed during printing, and for adjustably varying the rotational speed of the plate cylinder with respect to the traveling speed of the web with a view to positioning of the pair of images longitudinally of the web.

2. A web-fed, multicolor, offset printing press having a series of printing units for printing different color images on a continuous web of paper or like material traveling along a predefined path at a predetermined speed, each printing unit comprising:
(a) a plate cylinder split into a pair of halves for printing a pair of images in juxtaposition transversely of the web, the pair of halves of the plate cylinder being capable of independent displacement both axially and circumferentially of the plate cylinder for registration of the pair of images printed on the web with the other pairs of images printed by the other printing units;
(b) a blanket cylinder in rolling contact with the plate cylinder;
(c) a first pair of helical gears coaxially coupled to opposite ends of the plate cylinder for joint rotation therewith;
(d) a second pair of helical gears coaxially coupled to opposite ends of the blanket cylinder for joint rotation therewith, the second pair of helical gears being each in mesh with one of the first pair of helical gears for joint rotation of the plate cylinder and the blanket cylinder in opposite directions;
(e) axial adjustment means for causing axial displacement of each half of the plate cylinder independently of the other half with a view to fine positioning of each of the pair of images transversely of the web;
(f) circumferential adjustment means coupled to one of the first pair of helical gears for causing circumferential displacement of one of the halves of the plate cylinder relative to the other half by causing axial displacement of said one of the first pair of helical gears in sliding engagement with one of the second pair of helical gears, with a view to fine positioning of one of the pair of images longitudinally of the web; and
(g) drive means drivingly coupled to either of the first and the second pairs of helical gears for jointly driving the plate cylinder and the blanket cylinder in opposite directions at a predetermined speed during printing, and for adjustably varying the rotational speed of the plate cylinder with respect to the predetermined traveling speed of the web with a view to approximate and fine positionings of the pair of images longitudinally of the web.

3. The printing press of claim 2 wherein the plate cylinder has a pair of trunnions coaxially coupled one to each half thereof, and wherein the axial adjustment means comprises a pair of axial adjustments coupled one to each half of the plate cylinder of each printing unit, each axial adjustment comprising:
(a) frame means;
(b) an axial adjustment motor mounted to the frame means, the axial adjustment motor being capable of bidirectional rotation;
(c) a sleeve coaxially and rotatably mounted to one trunnion of the plate cylinder and constrained to axial displacement therewith and hence with one half of the plate cylinder relative to the frame means, the sleeve being driven for bidirectional rotation from the axial adjustment motor; and
(d) screw thread means acting between the frame means and the sleeve for causing the sleeve to travel axially back and forth with said one plate cylinder half upon bidirectional rotation of the sleeve.

4. The printing press of claim 2 wherein the plate cylinder has a pair of trunnions coaxially coupled one to each half thereof, and wherein the circumferential adjustment means comprises:
(a) frame means;
(b) a circumferential adjustment motor mounted to the frame means, the circumferential adjustment motor being capable of bidirectional rotation;
(c) a first annular gear nonrotatably mounted to one trunnion of the plate cylinder;
(d) a second annular gear concentrically surrounding the first annular gear and engaged therewith for joint rotation while being free to travel axially relative to the same, one of the first pair of helical gears being concentrically and nonrotatably mounted to the second annular gear;
(e) a sleeve coaxially and rotatably mounted to the second annular gear and constrained to axial displacement therewith and hence with one of the first pair of helical gears, the sleeve being driven for bidirectional rotation from the circumferential adjustment motor; and
(f) screw thread means acting between the frame means and the sleeve for causing the sleeve to travel axially back and forth with the second annular gear, and hence with said one of the first pair of helical gears, upon bidirectional rotation of the sleeve, said one helical gear on axial displacement being displaced circumferentially with one half of the plate cylinder by virtue of its engagement with one of the second pair of helical gears on the opposite ends of the blanket cylinder.

5. The printing press of claim 2 wherein the plate cylinder has a pair of trunnions coaxially coupled one to each half thereof, and wherein the axial adjustment means comprises a pair of axial adjustments coupled one to each half of the plate cylinder of each printing unit, each axial adjustment comprising:
(a) frame means
(b) an axial adjustment motor mounted to the frame means, the axial adjustment motor being capable of bidirectional rotation;
(c) a first sleeve mounted fast to the frame means, the first sleeve being threaded internally;
(d) a threaded rod extending through the first sleeve in threaded engagement therewith, the threaded rod being driven for bidirectional rotation from the axial adjustment motor and, on rotation, undergoing axial displacement by virtue of its threaded engagement with the first sleeve; and
(e) a second sleeve coaxially secured to one of the trunnions and coaxially coupled to the threaded rod so as to permit rotation of the latter while being constrained to joint axial displacement with the threaded rod.

6. The printing press of claim 5 wherein the circumferential adjustment means comprises:
(a) a circumferential adjustment motor mounted to the frame means, the circumferential adjustment motor being capable of bidirectional rotation;
(b) a third sleeve concentrically mounted to the threaded rod of one of the axial adjustment means and threadedly engaged therewith, the third sleeve being driven for bidirectional rotation from the circumferential adjustment motor and, on rotation, undergoing axial displacement by virtue of its threaded engagement with the threaded rod; and
(c) a fourth sleeve coaxially and rotatably coupled to the third sleeve and constrained to axial displacement therewith, the fourth sleeve being coaxially and nonrotatably coupled to the second sleeve of one of the axial adjustment means while being free to travel axially relative to the second sleeve;
(d) one of the first pair of helical gears being concentrically and nonrotatably mounted to the fourth sleeve and, on axial displacement with the fourth sleeve, being displaced circumferentially with one half of the plate cylinder by virtue of its engagement with one of the second pair of helical gears on the opposite ends of the blanket cylinder.

7. A web-fed, multicolor, offset perfecting printing press having a series of printing units for printing different color images on both sides of a continuous web of paper or like material traveling along a predefined path at a predetermined speed, each printing unit comprising:
(a) a pair of plate cylinders each split into a pair of halves for printing a pair of images in juxtaposition transversely of the web, the pair of halves of each plate cylinder being capable of independent displacement both axially and circumferentially of the plate cylinder for registration of the pair of images printed on one side of the web with the other pairs of images printed on the same side of the web by the other printing units;
(b) a pair of blanket cylinders in rolling contact one with each plate cylinder, the pair of blanket cylinders being held against each other via the web being printed upon;
(c) a first pair of helical gears coaxially coupled to opposite ends of each plate cylinder for joint rotation therewith;
(d) a second pair of helical gears coaxially coupled to opposite ends of each blanket cylinder for joint rotation therewith, the second pair of helical gears on each blanket cylinder being each in mesh with one of the first pair of helical gears on one plate cylinder for joint rotation of the plate cylinder and the blanket cylinder in opposite directions;
(e) axial adjustment means for causing axial displacement of each half of each plate cylinder independently of the other half thereof with a view to fine positioning of each of the pair of images transversely of the web;
(f) circumferential adjustment means coupled to one of the first pair of helical gears on each plate cylinder for causing circumferential displacement of one of the halves of the plate cylinder relative to the other half thereof by causing axial displacement of said one of the first pair of helical gears in sliding engagement with one of the second pair of helical gears on one associated blanket cylinder, with a view to fine positioning of one of the pair of images longitudinally of the web;
(g) first drive means drivingly coupled to either of the first and the second pairs of helical gears on one plate cylinder and one blanket cylinder for jointly driving said one plate cylinder and said one blanket cylinder in opposite directions at a predetermined speed during printing, and for adjustably varying the rotational speed of said one plate cylinder with respect to the predetermined traveling speed of the web with a view to approximate and fine positionings of the pair of images longitudinally of the web; and
(h) second drive means drivingly coupled to either of the first and the second pairs of helical gears on the other plate cylinder and the other blanket cylinder for jointly driving said other plate cylinder and said other blanket cylinder in opposite directions at the predetermined speed during printing, and for adjustably varying the rotational speed of said other plate cylinder with respect to the predetermined traveling speed of the web with a view to approximate and fine positionings of the pair of images longitudinally of the web.

8. The printing press of claim 7 wherein each of the first and the second drive means includes a cylinder drive motor coupled to one of the second pair of helical gears on one associated blanket cylinder via an intermediate gear of coaxial arrangement with one associated plate cylinder.
